(19) United States
(12) Patent Application Publication
(10) Pub. No.: US 2009/0248462 A1
(43) Pub. Date: Oct. 1, 2009

(54) Method, Apparatus And Computer Program Product For Capturing Knowledge During An Issue Resolution Process

(75) Inventors: Paulette H. DeGard, Kingston, WA (US); Gregory McCaslin, Bellevue, WA (US)

Correspondence Address: ALSTON & BIRD, LLP, BANK OF AMERICA PLAZA, 101 SOUTH TRYON STREET, SUITE 4000, CHARLOTTE, NC, 28280-4000, US

(73) Assignee: The Boeing Company, Chicago, IL (US)

(21) Appl. No.: 12/059,445

(22) Filed: Mar. 31, 2008

(51) Int. Cl. G06Q 10/00; G06F 17/30

(52) U.S. Cl. 705/7; 707/9; 707/E17.001

(57) ABSTRACT

A method, apparatus and computer program product are provided for capturing knowledge during an issue resolution process. The method, apparatus and computer program product facilitate the recording and subsequent location of knowledge such that the knowledge captured during this issue resolution process can be leveraged during subsequent issue resolution processes. The method, apparatus and computer program product are structured to capture various forms of knowledge including some forms of knowledge, such as telephone or other oral conversations, that have been inconsistently recorded in the past. Information that permits the categorization of the issue and/or that identifies one or more regulations, such as federal airworthiness regulations, that impact the issue may also be collected.

### FIELD OF THE INVENTION

Embodiments of the present invention relate generally to the capture of knowledge during an issue resolution process and, more particularly, to methods, apparatus and computer program products for orderly knowledge capturing during an issue resolution process in order to provide a context for the issue resolution process, a timeline showing when communications took place, and to facilitate subsequent reliance upon the knowledge captured during the issue resolution process.

### BACKGROUND OF THE INVENTION

A number of industries are now knowledge-driven with many of the corporate assets embodied as knowledge that has been developed or acquired by a company in contrast to conventional physical assets. For example, the engineering, finance, sales/marketing and legal functions of a company may generate significant knowledge which is of value to the company. Unfortunately, much of this knowledge is only retained in the memories of the employees and has not been recorded. For example, the knowledge gained or conveyed during phone conversations or email oftentimes goes undocumented in the case of telephone conversations or unpreserved in the case of email messages such that the knowledge imparted by these exchanges may quickly be lost. Even of the knowledge that has been recorded, the record of the knowledge may be difficult or at least time-consuming to identify and retrieve. Often these records are written on note pads in no particular order and are later discarded.

Historically, the knowledge that was recorded in tangible form was generally stored in file cabinets. If organized at all, the file cabinets may have been organized either in a chronological fashion, on a project basis or based upon the identity of the individual who provided the knowledge. As such, even if knowledge has been recorded in a tangible form and stored in a file cabinet or elsewhere, locating those records can prove to be a challenge in light of the numerous physical storage locations which may be scattered throughout a company's facilities as well as the various organizational schemes employed by the company's personnel. Additionally, personnel are often moved to other projects and at times department or project numbers are also changed. This presents a problem when file cabinets are organized as such. For personnel looking for a physical file based on this changed information will dramatically increase the search time without having a historical background. As the recording of knowledge has transitioned, at least partly, from physical file cabinets to computerized storage, the difficulties associated with locating previously stored information have remained, if not been exacerbated. In this regard, files which may record knowledge may be stored on various computers and other computer media including, for example, various computers associated with individual employees of the company, network servers, and other mainframe computers maintained by the company to provide a more centralized storage and processing function as well as various types of storage media including compact discs, computer diskettes, computer tapes, etc. In addition to the multitude of computer storage possibilities, the organizational structure of such computer storage and the naming conventions associated with the computer files, folders, etc., are oftentimes quite inconsistent and may lack in any meaningful organization or convention and, instead, appear to be dictated by individual preferences.

Regardless of whether the knowledge is stored in file cabinets or in a computer system, the knowledge may be difficult to locate, thereby potentially requiring the expenditure of excessive amounts of time in an effort to locate the knowledge. In this regard, the desire to access the knowledge may occur in a variety of instances including instances in which an issue which currently confronts a company was previously addressed and it is desired to review the prior resolution of the issue. Additionally, a company receiving a service request in conjunction with a product that was designed and/or manufactured some time ago may desire to access knowledge and the personnel involved relating to the original design and/or manufacture of the product in order to appropriately address the service request. Further, difficulties associated with locating documents, records, or other files may cause employees to simply abort any efforts to locate the prior documentation or to never search for the prior documentation in the first instance and, to instead, address the issue anew without the benefit of the prior knowledge. Not only is this resolution inefficient, but this resolution will not take advantage of or otherwise leverage the experience and lessons learned during a prior resolution of the same or a similar issue. All too frequently this information is needed in a timely manner, but is not accessible in a quick format. As will be apparent, the problems associated with the identification and location of knowledge will likely become more significant as workers, particularly long-time employees, retire—an increase in which is expected as the baby boomers begin to reach retirement age.

In addition to the inefficiencies created by a failure to effectively identify and locate knowledge, this failure may create additional disadvantages. In this regard, it is frequently desirable to provide a consistent response when confronted with the same or a similar issue, thereby promoting consistency and repeatability which, in turn, foster confidence. In instances in which the knowledge associated with a prior resolution of the same or similar issue cannot be identified and/or located, the risk that the issue will now be addressed in a manner inconsistent to the way in which the same or a similar issue was addressed in the past is undesirably heightened. Conversely, without ready access to knowledge defining the context of a prior resolution, the possibility exists that the prior resolution may be blindly adopted when confronted with the same or similar issue. However, if the context of the issue, such as the underlying assumptions, the ultimate goal, or other circumstances, differs from those associated with the prior issue, such blind adoption may be inappropriate. Indeed, in light of the different context associated with the issues, this decision may prove to be incorrect or at least less than ideal.

As such, it would be desirable to provide an improved technique for capturing knowledge during an issue resolution process. In this regard, it would be desirable to provide an improved technique for capturing knowledge which facilitates the subsequent identification and location of the knowledge and which includes ample contextual information to facilitate a more complete understanding of the prior issue resolution process.

### BRIEF SUMMARY OF THE INVENTION

A method, apparatus and computer program product are therefore provided in accordance with one embodiment of the present invention for capturing knowledge during an issue resolution process. In this regard, the method, apparatus and computer program product facilitate the recording and subsequent location of knowledge such that the knowledge captured during this issue resolution process can be leveraged during subsequent issue resolution processes, thereby increasing the efficiency and repeatability with which issues can be resolved. Moreover, the method, apparatus and computer program product of embodiments of the present invention are structured to capture various forms of knowledge including some forms of knowledge, such as telephone or other oral conversations, that have been inconsistently recorded in the past, thereby providing not only for greater knowledge retention, but also increased contextual awareness of prior issue resolution processes.

In one embodiment, a method for capturing knowledge during an issue resolution process is provided which receives an identification of the issue along with associated personnel and a categorization of the issues. For example, the categorization of the issue may include the identification of a model of a product with which the issue is associated. The method receives also an identification of an action plan for addressing the issue. In receiving the identification of the action plan, the method also permits an identification of one or more regulations, such as federal regulations, that impact the issue. The method also receives information regarding execution of the action plan and then stores the identification of the issue, the identification of the action plan and the information regarding execution of the action plan. In conjunction with receiving the identification of the action plan and/or information regarding execution of the action plan, the method also permits entry of information identifying one or more documents related to the issue, the action plan and/or the execution of the action plan.

Further, in conjunction with receiving the identification of the issue, receiving the identification of the action plan and/or receiving information regarding execution of the action plan, the method also provides for receipt of journal input in order to capture additional related information. While the method may provide for the receipt of journal input in conjunction with one or more of the receiving steps, the method of one embodiment provides for the receipt of journal input during each receiving step, that is, while receiving the identification of the issue, while receiving the identification of the action plan, and while receiving information regarding execution of the action plan. Among other things, the receipt of journal input may include receiving a record of a conversation relating to the issue. By facilitating the receipt of journal input, the method of one embodiment facilitates the capture of knowledge which may have historically gone undocumented. As such, the records of conversations and other journal input facilitate an understanding of the issue resolution process and the context in which the issue resolution process was conducted. As such, subsequent analysis of the issue resolution process can benefit from the capture of the journal input provided by embodiments of the present invention.

In one embodiment, the receipt of the request for an issue resolution includes receipt of information identifying one or more instances in which the issue was previously raised. The method may also receive an estimate of the time required to resolve an issue in conjunction with the receipt of the identification of the issue and/or the receipt of the identification of the action plan. In this embodiment, the receipt of information regarding execution of the action plan may include receipt of the actual time required to resolve the issue. In another embodiment, the method may receive an estimated date by which the issue is to be resolved in conjunction with the receipt of the identification of the issue and/or the receipt of the identification of the action plan. The method of this embodiment may also receive information identifying an actual date by which the issue was resolved in conjunction with receipt of information regarding execution of the action plan. In these embodiments, information regarding the time and/or date of issue resolution can assist in determining the accuracy of the estimate and can also assist in identifying instances, particularly repeated instances, of inefficiency or tardy performance.

By capturing knowledge during the issue resolution process, the method of embodiments of the present invention facilitates identification and retrieval of the knowledge during subsequent issue resolution processes by capturing various types of knowledge as well as knowledge indicative of the context of the issue resolution process, such as that provided by the identification of one or more regulations that impact the issue. Subsequent review of the issue resolution process can place the knowledge and the approach taken during the prior issue resolution process in context such that the knowledge can be appropriately leveraged in subsequent issue resolution processes in an efficient and effective manner.

A corresponding apparatus and computer program product are also provided according to other embodiments of the present invention for capturing knowledge during an issue resolution process. In this regard, the apparatus includes a processor which is configured to perform the functions associated with the capture of knowledge during an issue resolution process. Similarly, a computer program product includes a computer-readable storage medium having computer readable code embodied in the storage medium and including executable portions for performing the functions associated with capturing knowledge during an issue resolution process. As such, the method, apparatus and computer program product of embodiments of the present invention advantageously provide improved techniques for capturing more meaningful knowledge during an issue resolution process in order to facilitate subsequent identification and review of the knowledge.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a computer network for capturing knowledge during an issue resolution process in accordance with one embodiment of the present invention;

FIG. 2 is one example of a home page provided in accordance with one embodiment of the present invention for presenting various options relating to the issue resolution process to a user;

FIG. 3 is an example of an issue input form in accordance with one embodiment of the present invention in order to solicit and receive information regarding an issue;

FIGS. 4A-4C are flowcharts of the operations performed in accordance with one embodiment of the present invention;

FIG. 5 is one example of a form for receiving information regarding the discovery and test phase of one embodiment of the issue resolution process of the present invention; and

FIG. 6 is an example of a form regarding the validation, approval and implementation phase of the issue resolution process in accordance with one embodiment of the present invention.

### DETAILED DESCRIPTION OF THE INVENTION

The present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

According to embodiments of the present invention, methods, apparatus and computer program products are provided for capturing knowledge during an issue resolution process. Such an issue resolution process can be employed in a variety of different industries and in conjunction with the resolution of a wide variety of issues. For example, one embodiment of the method, apparatus and computer program product will be hereinafter described in conjunction with the resolution of an issue relating to the use of an auxiliary power unit (APU) during takeoff and landing of an aircraft. However, this example is merely provided by means of illustration and does not limit the wide variety of industries and issues for which the method, apparatus and computer program product can be designed to address.

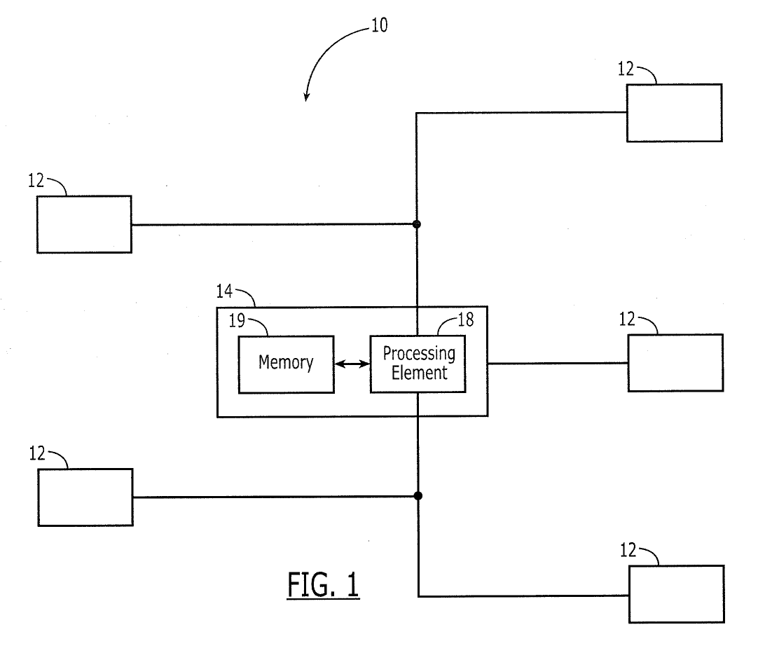

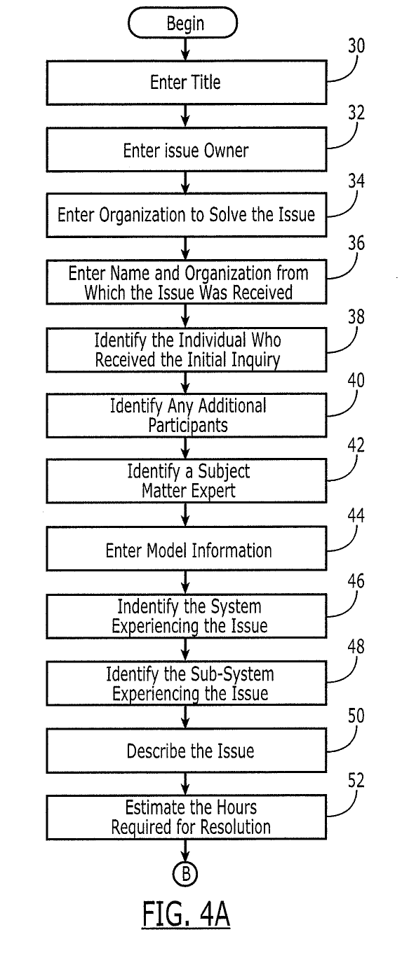

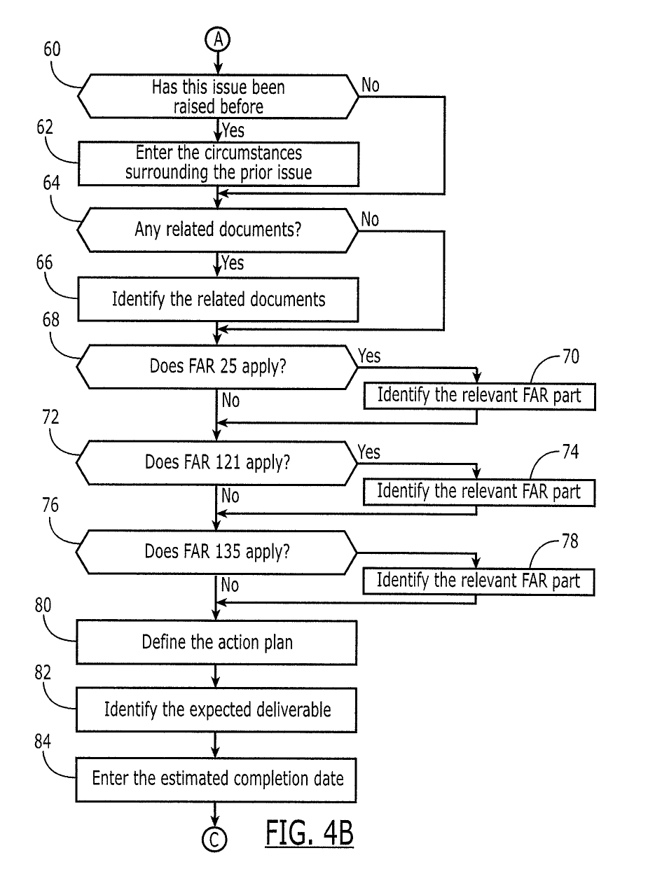

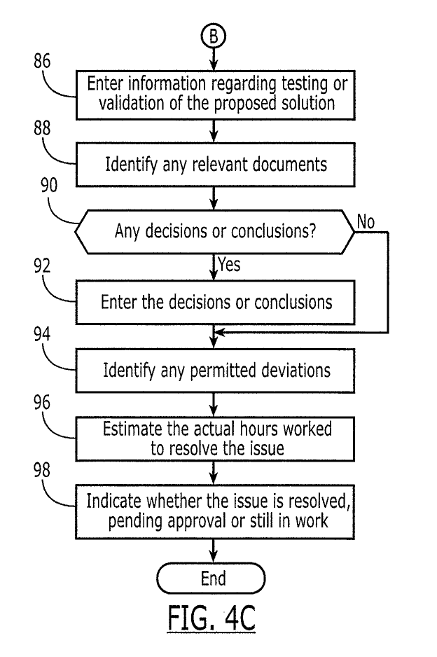

As shown in FIG. 1, embodiments of the present invention are typically deployed in a computer system 10 having a plurality of computing devices 12, such as user workstations, personal computers, or other client devices (hereinafter generically referred to as “workstations”), interconnected via a network, such as a wide area network such as an intranet or the internet, a local area network, or the like. The computer system also generally includes one or more network entities 14, such as servers or other computing devices (hereinafter generically referred to as “servers”), for processing and storing data and for communicating with the plurality of computing devices. As also shown in FIG. 1, the server 14 can include a processing element 18, such as a processor, controller or the like, and an associated memory device 19, both of which are commonly comprised by a computer or the like. In this regard, the method of embodiments of the present invention as set forth generally in FIGS. 4A-4C and described below can be performed by the processing element executing computer program instructions stored by the memory device. The memory device may also store the data in some embodiments.

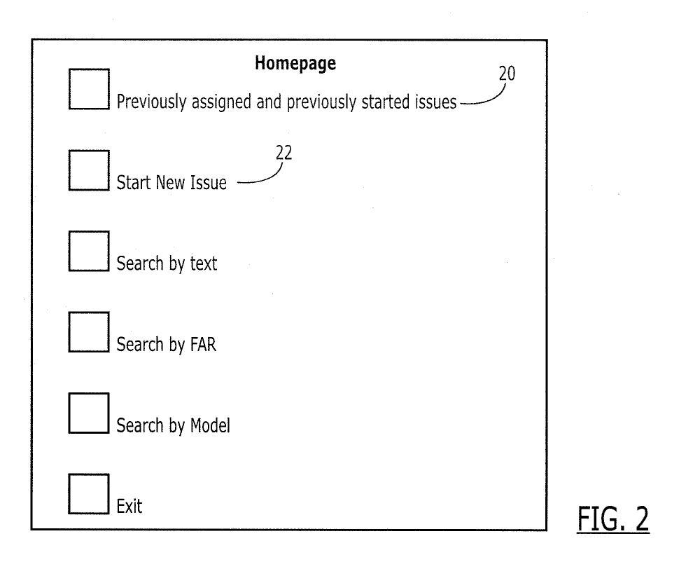

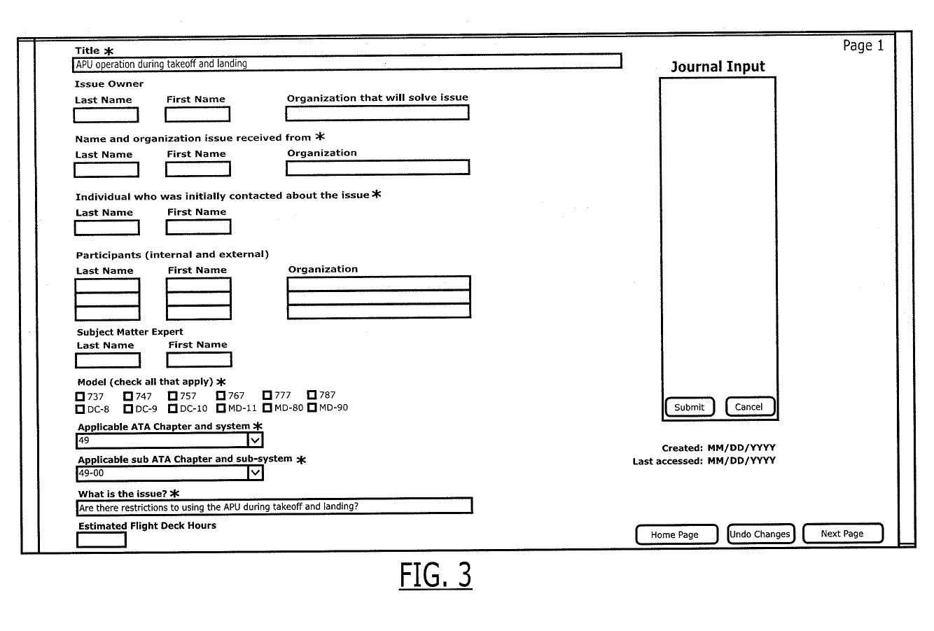

As an initial matter, a user would typically access a home page that may be provided by the server 14 and displayed by the user's workstation 12. One example of a home page in the form of an interactive web page is provided by FIG. 2. Among other options which will be discussed hereinbelow, the user may elect a first option 20 to view previously assigned issues or a second option 22 to initiate a new issue. As used herein, an issue may be any particular project, question, matter, etc. which requires some resolution and, therefore, typically requires some deliberation, research or other thought process in order to arrive at the resolution. In instances in which the user elects to initiate a new issue, a user is generally presented with an issue entry form, such as via an interactive web page as shown in FIG. 3, in order to solicit and receive information from the user defining and otherwise related to the issue. While some embodiments may require that information is entered into each field of a form, such as the forms of FIGS. 3, 5 and 6, other embodiments may only require the entry of information in certain select fields, such as those marked with an asterisk in FIGS. 3, 5 and 6. As with the home page, the issue input form may be provided by the server 14 and displayed by the user's workstation 12. As shown in FIG. 3 and as depicted in the flow chart of FIG. 4A, the issue input form solicits a title, the identification of an individual who will own and, therefore, be responsible for the resolution of the issue, and the organization that will be tasked with solving the issue. See blocks 30-34 of FIG. 4A. Further, the name and the organization from which the issue was received as well as the individual who received the initial inquiry, such as a telephone call, regarding the issue may be identified. See blocks 36 and 38 of FIG. 4A. Additional participants in the origin or resolution of the issue may also be identified as well as any subject matter experts having particular knowledge with respect to this issue. See blocks 40 and 42 of FIG. 4A.

In order to appropriately categorize the issue, the model or product name of a product or service for which the issue is relevant may be identified. See block 44 of FIG. 4A. In the illustrated embodiment, for example, the issue relates to the operation of an APU during takeoff and landing of a 737 aircraft. As such, the model of the product with which the issue is associated is identified as a 737 aircraft. In order to further categorize the issue, the particular system, subsystem or other subassembly or part with which the issue relates may also be identified. In regards to the illustrated embodiment in which the issue relates to an aircraft, the particular Air Transport Association (ATA) chapter may be identified since the ATA chapter, in turn, effectively identifies the system of the aircraft with which the issue relates, e.g., navigation, landing gear, lights, etc. See block 46 of FIG. 4A. Further subdivision and details regarding the subsystem or more specific subassembly or part with respect to which the issue relates may also be identified, such as by identifying the ATA subchapter in embodiments in which the issue relates to an aircraft in order to correspondingly identify the subsystem of the aircraft with which the issue relates. See block 48 of FIG. 4A. As shown in conjunction with the identification of the related system and subsystem information, the issue intake form may include a drop down menu which identifies the universe of applicable systems and subsystems to facilitate user selection and entry. Similarly, while other fields which are completed by the user may receive free form text input, at least some of the other fields may also include a drop down listing or other information identifying the potential candidates or the most likely candidates for the respective field. If this system was used for financing, the illustrated embodiment could be related to particular financing or accounting functions. As an example, an issue could be associated to a function of Balance Sheet with a sub-function of Stockholder's Equity.

The issue input form also solicits a description of the issue, such as in freeform text. See block 50 of FIG. 4A. As shown by the illustrated embodiment, the issue may be phrased in terms of the question to be answered, such as the question posed by a customer, a service technician or the like. In the illustrated embodiment, for example, the issue with respect to the operation of the APU is whether there are restrictions on using the APU during takeoff and landing. Finally, the issue input form solicits an estimation of the hours to resolve the issue, such as five hours in the illustrated embodiment. See block 52 of FIG. 4A.

Notably, the issue input form, as well as the other forms with which a user interacts and which will be described below, include a journal input field. The journal input field permits the user to enter any other information relevant to the issue, typically in a freeform manner. By providing for journal input in a readily accessible manner, the method, apparatus and computer program product of embodiments of the present invention permit a wide variety of other information related to the issue to be captured even though the information may not be directly related to any of the particular fields of the user input form or any of the other forms. Among other types of information, the journal input field can advantageously receive a record of telephone conversations or other oral conversations that the user may have had regarding the issue and its resolution. As such, the additional information provided by the user via the journal input field is maintained for future reference purposes and, as described below, may provide meaningful insight into the context of the issue resolution process or the thought process that led to the resolution of the issue. Moreover, in the illustrated embodiment, a journal entry can be submitted separately from the submission of the entire form by actuation of the “Submit” button positioned within the journal input field. As such, one or more journal entries can be submitted while the form remains open and is being completed. Additionally, a user can return to a form that was previously completed and submitted and enter and submit an additional journal entry.

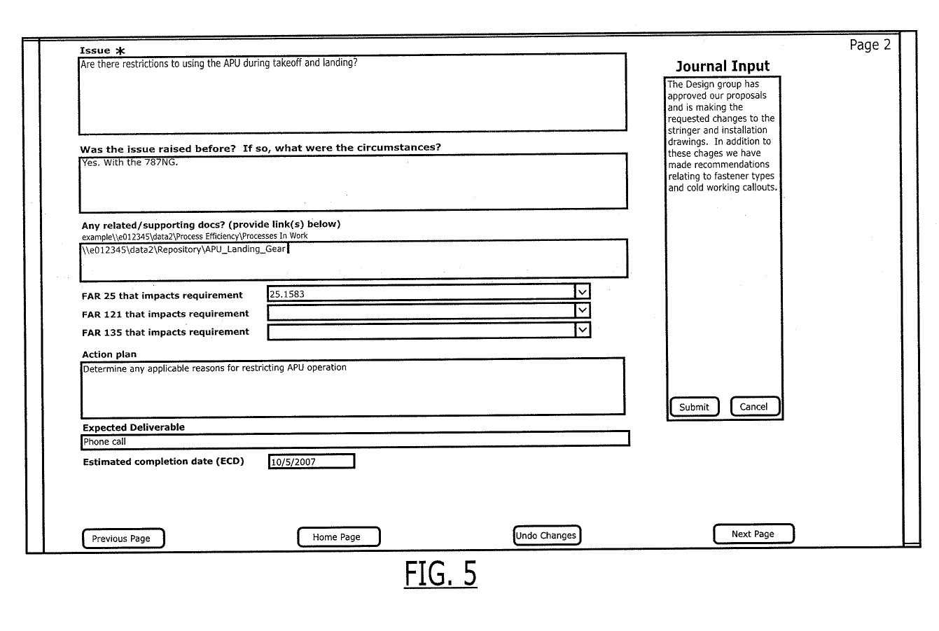

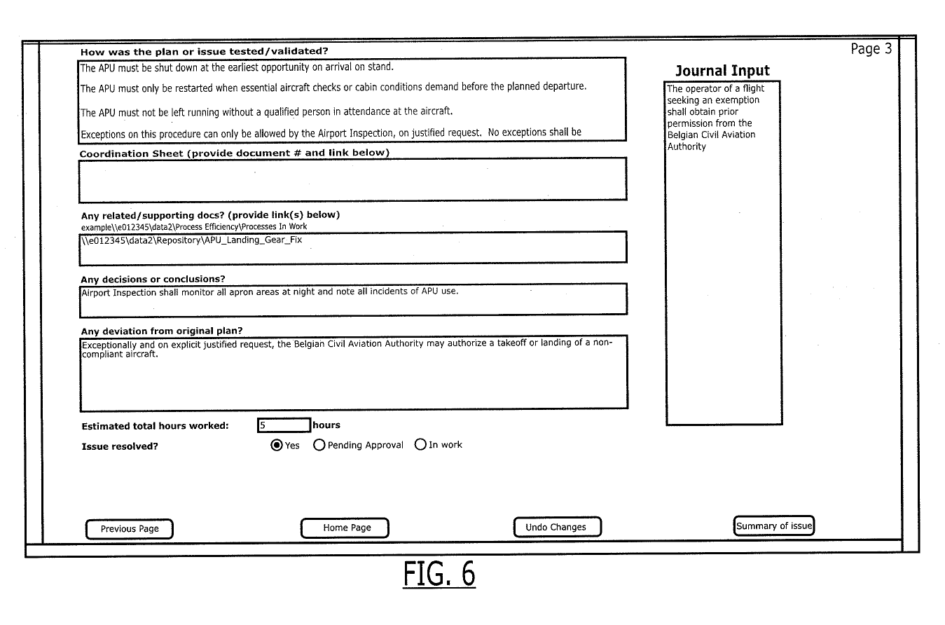

Once the issue input form has been completed, the user may submit the form which is then stored, typically by the server 14. To submit the form pages represented by FIGS. 3 and 5, the “Next Page” or Home Page” buttons may perform this function. To submit the form page represented by FIG. 6, the button “Summary of Issue” may perform this function. A pop up box may confirm with the user if they in fact want to submit the form. The form may remain editable by authorized individuals until the “Issue Resolved?” is marked “Yes”. Once this entry is marked “Yes”, the record may be locked and no longer editable. Personnel may then only be able to make comments about the issue with those comments designated as such. As noted by FIG. 3, the system 10 generally determines and maintains the date and, in some instances, time information regarding when the issue was initially created and when the issue was last accessed and when a “Journal Input” was submitted,

Once the issue has been identified and input into the system 10, the system and, more typically, the server 14 may assign the resolution of the issue to the owner of the issue who was identified by the issue input form. If desired, the owner of the issue can then assign the resolution of the issue to another person. Once assigned to a person, the issue will be included in the listing of issues assigned to a user which is displayed upon selection of the first option 20 of the home page depicted in FIG. 2. Following assignment of the resolution of the issue, a discovery and test phase is generally entered in which one or more authorized individuals endeavor to resolve the issue. In order to document the resolution of the issue as well as the context of the issue resolution process, the manner by which the resolution was arrived at and, potentially, other options which were considered but were discarded or otherwise not pursued as well as any rationales for discarding or otherwise failing to pursue these other options, a form that documents the discovery and test phase may be provided, as shown in FIG. 5. As described above in conjunction with the home page and the issue input form, the form associated with the discovery and test phase may be an interactive web page provided by the server 14 and accessible via the user's workstation 12.

As shown, the form associated with the discovery and test phase generally identifies the issue, typically in the same manner as identified by the issue input form, and then solicits input as to whether the issue was raised before and, if so, the circumstances surrounding each instance in which the issue was raised before. See blocks 60 and 62 of FIG. 4B. Any documentation that relates to the issue and its resolution are also identified, such as by means of links to the respective documents located in the repository. See blocks 64 and 66 of FIG. 4B. In this regard, the documents which are identified may relate to documents created during the prior resolution of the same or a similar issue as described above in conjunction with block 62 of FIG. 4B. Alternatively, the documents that are identified may be documents that are created or updated during the resolution of the particular issue at hand. Any of a variety of documents having any of a variety of types, such as text documents, images, graphical representations, spreadsheets or the like, may be identified and links to the respective documents may be provided to facilitate access to the documents.

The method, apparatus and computer program product of embodiments of the present invention also solicit the identification of one or more regulations that impact the issue, such as by defining or otherwise limiting the manner in which the issue may be resolved or otherwise describing conditions which must be taken into account in the resolution of the issue. In regards to the illustrated embodiment in which an issue relating to an aircraft is in process, an identification of a federal airworthiness regulation (FAR) may be identified. In this regard, the form associated with the discovery and test phase may identify particular types or classes of regulations and solicit information as to any specific regulations of the identified types or classes which are applicable. In the illustrated embodiment, for example, the form associated with the discovery and test phase specifically solicits information regarding particular FAR provisions from among FAR 25, FAR 121 and FAR 135 that may impact the resolution of the issue with FAR 25.1583 being identified in the illustrated embodiment. See blocks 68-78 of FIG. 4B. As known to those skilled in the art, FAR 25 is entitled Airworthiness Standards: Transport Category Airplanes. FAR 121 is entitled Operating Requirements: Domestic, Flag, and Supplemental Operations and FAR 135 is entitled Operating Requirements: Commuter and On Demand Operations and Rules Governing Persons On Board Such Aircraft. While three FAR parts are identified, other regulations, such as other FAR parts, may be similarly identified, such as FAR 23 entitled Airworthiness Standards: Normal, Utility, Acrobatic and Commuter Category Airplanes, FAR 45 entitled Government Property and FAR 91 entitled General Operating and Flight Rules. While the form associated with the discovery and test phase of the illustrated embodiment depicts the entry of a single FAR provision in FIG. 5, multiple regulations, such as multiple FAR provisions, may impact or otherwise guide the resolution of the issue and, therefore, the user may identify multiple FAR provisions in these embodiments. As noted above with respect to the issue input form, the fields which receive the entry of a relevant regulation may include a drop down list of the potentially applicable regulations. In regards to the form associated with the discovery and test phase depicted in FIG. 5, for example, a drop down list may be associated with the inquiry regarding any requirements of FAR 25 that may be relevant and, as such, may provide a list of the provisions of FAR 25 which are potentially relevant and from which the user may select one or more provisions. Similarly, drop down lists may be associated with the other regulations at issue, such as FAR 121 and FAR 135, to provide a list of the potentially relevant provisions for selection by the user. If this system was to be used with financing, the illustrated embodiment could be related to accounting federal regulations. In the case of accounting, titles and subsequent sections of the Sarbanes-Oxley Act or other regulations of the Securities and Exchange Commission can be identified to a particular issue.

The form associated with the discovery and test phases may also permit the user to define the action plan, typically in free form text. See block 80 of FIG. 4B. In the illustrated embodiment, for example, the action plan is defined as “determine any applicable reasons for restricting APU operation.” Further, the form associated with the discovery and test phase permits the user to identify the expected deliverable, such as a written report, a phone call, a proposed resolution coordination sheet, a budgetary estimate, etc. See block 82 of FIG. 4B. Furthermore, the estimated completion date (ECD) is solicited. See block 84 of FIG. 4B. As before, a journal input field is provided which permits the user to enter any other relevant information related to the discovery and test phase of the issue resolution process in order to provide more insight into the manner in which the action plan was defined and the manner in which the resolution was determined and/or tested. With each journal input, an associated date and time is made to provide a timeline of the context. Once the form associated with the discovery and test phase has been completed and a proposed solution has been submitted, the form associated with the discovery and test phase may be submitted, thereby permitting storage by the server or the like. As described above, the journal input fields permit entry of additional information that may have historically become lost, such as summaries of phone or other conversations and email or SME exchanges. In this regard, the information imparted by these oral conversations can be recorded to provide a more detailed record of the manner in which the issue was resolved, both for establishing the context of the issue resolution process and for permitting a more detailed review of the manner in which the issue was resolved, such as during the resolution of another related issue.

The submission of the completed form relating to the discovery and test phase permits a form associated with the validation, approval and implementation of the proposed solution to be provided to the user as shown in FIG. 6, such as by being provided by the server 14 to the user's workstation 12, for completion by the user in order to record the information relevant to this phase to the issue resolution process. In the embodiment depicted in FIG. 6, for example, information regarding the manner in which the proposed solution is tested or validated is provided, typically by means of a free form text entry. See block 86 of FIG. 4C. Any supporting documentation related to the testing and validation of the proposed solution is then identified, such as by document number and/or a link to each document. See block 88 of FIG. 4C. Among the documents which are identified may be a requirements document or specification relating to the test and validation of the proposed solution. Additionally, a coordination sheet may be created with the coordination sheet defining statement of work tasks between personnel. In providing the coordination sheet number and link to the document, the system of this embodiment will give users more context regarding the issue. In addition to the identification of related or supporting documentation, any decisions or conclusions following the testing and validation phase of the issue resolution process are captured. See blocks 90 and 92 of FIG. 4C. As reflected by the illustrated embodiment, the decisions or conclusions may include changes to current methods of operation or other activities that should be undertaken or on which renewed emphasis should be placed. In the illustrated embodiment in which the solution is for the APU: (i) to be shut down at the earliest opportunity upon arrival of the aircraft on the stand, (ii) to only be restarted under certain conditions and (iii) to not be left running without a qualified person in attendance, the decisions or conclusions relate to the monitoring of the apron areas to identify all incidents of APU use so that appropriate follow up can be conducted. Additionally, the form associated with the validation, approval and implementation phase may solicit information regarding instances in which a deviation may be permitted from the proposed solution as well as any conditions upon the deviation. See block 94 of FIG. 4C. In the illustrated embodiment, for example, the takeoff or landing of a noncompliant aircraft may be authorized in exceptional circumstances and in response to an explicit justified request by the Federal Aviation Administration or other regulatory agencies.

The form associated with the validation, approval and implementation phase may also estimate the total hours which were actually worked to resolve the issue. See block 96 of FIG. 4C. Further, the form associated with the validation, approval and implementation phase can indicate whether the issue has been resolved, whether approval is pending for the proposed solution or whether the resolution of the issue remains open and is still in work. See block 98 of FIG. 4C.

As described above, the form associated with the validation, approval and implementation phase may also include a journal input field for receiving additional information relating to the validation, approval and implementation of the proposed solution that is not otherwise solicited or included in a respective field of the form. As also described above, the journal input can be provided in various manners including, for example, as free form text. In instances in which the issue has not been resolved, but is not pending approval and does not remain in work, information regarding the failure to resolve the issue may also be provided, either by means of an optional dedicated field or in conjunction with the field that details the manner in which the proposed solution was tested and/or validated. Upon completion of the form associated with validation, approval and implementation, the form may be submitted, such as to the server 14 for storage. Once this form is marked “Yes” that the issue has been resolved, the record is locked and is not editable. Personnel will only be able to make journal comments about the issue and these comments will be designated as such. The time and date at which the issue was resolved may also be determined and stored by the server upon submission of the form associated with the validation, approval and implementation phase.

In addition to entering a new issue, a user may access a listing of issues previously assigned to the user and/or previously entered by the user. The issue owner can be both assigned by a manager, a lead or from an internal or external customer. With reference to FIG. 2, for example, the user may access the home page and may select the first option 20 to view a list of previously assigned issues. In response, the server 14 can identify those issues previously assigned to the respective user and can then provide a listing of the previously assigned issues. In one embodiment, the listing is provided by means of an interactive web page which includes a plurality of links, one of which is associated with each of the issues associated with the user. By selecting one of the links, the user is provided access to the information and other knowledge that has been gathered with respect to the respective issue and can access one or more of the forms described above in conjunction with FIGS. 3, 5 and 6 depending upon the phase of resolution of the issue. Moreover, in instances in which the user during a prior session has only partly completed a form for a particular issue, subsequent selection of the issue by the user can cause the partly completed form to be presented to the user in order to solicit the remainder of the information in order to complete the form and advance the issue resolution process or at least the documentation of the issue resolution process.

In addition to initiating entry of a new issue or viewing previously assigned or previously initiated issues, a user may be permitted to search for any of a variety of previously entered issues, such as via the home page. In this regard, the server 14 can support a variety of different search methodologies including text searching of either the entire database or only certain fields of the forms such as the titles of the issues. Based upon the results of the search, the user can then select one or more of the issues for further review.

As illustrated in FIG. 2, the home page may also advantageously permit existing issues to be filtered, such as based upon key words or phrases and/or based upon the categorization of the issues, e.g., the model, system, subsystem, subassembly, part, etc., and/or based upon the relevant regulation(s) that impact the issues. In this regard, a user can search for relevant issues based upon the model, such as the model of aircraft, to which the issue is relevant and/or may search for relevant issues based upon the regulations which govern or otherwise impact the resolution of the issue. In response to a search for issues by model, the server 14 can provide a listing of each of the issues associated with each model for the user's consideration. Similarly, the server can provide a listing of each of the issues associated with or otherwise impacted by each regulation, such as a listing of issues associated with each FAR section. The home page may also permit a user to browse all of the records, either chronologically or alphabetically.

As such, a company faced with similar issues over the course of time can understand the manner in which prior similar issues were resolved and can determine whether the context of the prior issue is applicable for the current issue. If the context of the prior issue resolution process and the current issue are the same or sufficiently similar, a company can learn from the resolution of the prior issue and resolve the current issue in a more expedited and consistent manner by relying, either entirely or at least partially, upon the resolution of the prior similar issue. Alternatively, if the context associated with the resolution of the prior issue was different than the current issue, the resolution of the prior issue need not be blindly adopted and, instead, the current issue can be resolved at least partially independently of the resolution of the prior similar issue in order to take into account the different contexts.

In addition to providing for journal input to record and memorialize information relating to the resolution of an issue that may otherwise not have been captured, such as conversations or telephone calls, the method, apparatus and computer program product of embodiments of the present invention also capture information that facilitates the work flow process. In this regard, information is gathered via the issue input form as to the estimated hours to resolve the issue as well as the estimated date of completion. Similarly, upon resolution of the issue, the hours which were actually required to resolve the issue as well as the date on which the issue was actually resolved are also recorded. By comparing the initial estimates of one or both of the hours and date to the actual hours and/or date of resolution, information regarding the accuracy of the initial estimates can be gathered. While this information can be gathered on an organizational level, this information can also be gathered relative to particular individuals, such as the individuals initially inputting the issue and providing the initial estimates. As such, if one or more of the individuals who originally input the issues habitually err by more than a predetermined amount, such as by more than a predetermined percentage, from the actual number of hours or date of resolution, feedback may be provided to the individual regarding a need to improve their estimations and suggestions may be provided as to the average deviations between the estimated number of hours to resolve the issue and/or the estimated date of completion in comparison to the actual hours and/or date.

Additionally, issues that remain unresolved following the estimated date of completion or following the expenditure of more than the estimated number of hours for resolution may be further analyzed in order to identify the owners of the respective issues. As such, the owners of these unresolved issues can be contacted to solicit updated estimates regarding the number of hours required to complete the resolution of the issue or an updated date by which the issue is anticipated to be resolved. Furthermore, individuals who are owners of more than a predetermined number of issues which remain unresolved beyond the estimated date of completion or which have required more than the estimated number of hours to resolve can be identified and can receive feedback, either directly or via management, regarding a desire to resolve the issues in an expeditious manner or at least in a manner consistent with the original estimates, thereby attempting to reduce bottlenecks in the issue resolution process.

As indicated above, the processing element 18 of the server 14 may operate under control of a computer program product according to another aspect of the present invention. The computer program product for performing the methods of embodiments of the present invention includes a computer-readable storage medium, such as the non-volatile storage medium, e.g., memory device 19, and computer-readable program code portions, such as a series of computer instructions, embodied in the computer-readable storage medium.

In this regard, FIGS. 4A-4C depict the operations performed by the methods, systems and program products according to exemplary embodiments of the present invention. It will be understood that each operation can be implemented by computer program instructions. These computer program instructions may be loaded onto a computer or other programmable apparatus, e.g., processing element 18, to produce a machine, such that the instructions which execute on the computer or other programmable apparatus create means for implementing the operations illustrated in FIGS. 4A-4C. These computer program instructions may also be stored in a computer-readable memory that can direct a computer or other programmable apparatus to function in a particular manner, such that the instructions stored in the computer-readable memory produce an article of manufacture including instruction means which implement the operations illustrated in FIGS. 4A-4C. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the operations illustrated in FIGS. 4A-4C. It will also be understood that the operations illustrated in FIGS. 4A-4C can be implemented by special purpose hardware-based computer systems which perform the operations, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for capturing knowledge during an issue resolution process, the method comprising:
receiving an identification of the issue along with associated personnel and a categorization of the issue;
receiving an identification of an action plan for addressing the issue, wherein receiving the identification of the action plan comprises permitting an identification of one or more regulations that impact the issue;
receiving information regarding execution of the action plan; and
storing the identification of the issue, the identification of the action plan and the information regarding execution of the action plan,
wherein at least one of receiving the identification of the action plan or receiving information regarding execution of the action plan comprises permitting entry of information identifying one or more documents related to at least one of the issue, the action plan or the execution of the action plan, and
wherein at least one of receiving the identification of the issue, receiving the identification of the action plan or receiving information regarding execution of the action plan comprises providing for receipt of journal input in order to capture additional related information.

2. A method according to claim 1 wherein each of receiving the identification of the issue, receiving the identification of the action plan and receiving information regarding execution of the action plan comprises providing for receipt of journal input.

3. A method according to claim 1 wherein providing for receipt of journal input comprises receiving a record of a conversation relating to the issue and associating a time with the conversation.

4. A method according to claim 1 wherein permitting an identification of one or more regulations comprises receiving an identification of one or more regulations that impact the issue.

5. A method according to claim 1 wherein receiving the identification of the action plan comprises receiving information identifying one or more instances in which the issue was previously raised.

6. A method according to claim 1 wherein receiving the identification of the issue along with a categorization of the issue comprises receiving a model of a product with which the issue is associated.

7. A method according to claim 1 wherein at least one of receiving the identification of the issue or receiving the identification of the action plan comprises receiving an estimate of time required to resolve the issue, and wherein receiving information regarding execution of the action plan comprises receiving information identifying actual time required to resolve the issue.

8. A method according to claim 1 wherein at least one of receiving the identification of the issue or receiving the identification of the action plan comprises receiving an estimated date by which the issue is to be resolved, and wherein receiving information regarding execution of the action plan comprises receiving information identifying an actual date by which the issue was resolved.

9. A computer system for capturing knowledge during an issue resolution process, the computer system comprising:
a memory; and
a processor configured to receive: (i) an identification of the issue along with associated personnel and a categorization of the issue, (ii) an identification of an action plan for addressing the issue and (iii) information regarding execution of the action plan, said processor also configured to store in said memory the identification of the issue, the identification of the action plan and the information regarding execution of the action plan,
wherein in receiving the identification of the action plan, said processor is further configured to permit an identification of one or more regulations that impact the issue,
wherein in receiving at least one of the identification of the action plan or information regarding execution of the action plan, said processor is further configured to permit entry of information identifying one or more documents related to at least one of the issue, the action plan or the execution of the action plan, and
wherein in receiving at least one of the identification of the issue, the identification of the action plan or information regarding execution of the action plan, said processor is further configured to provide for receipt of journal input in order to capture additional related information.

10. A computer system according to claim 5 wherein said processor is further configured to provide for receipt of journal input in conjunction with receiving the identification of the issue, receiving the identification of the action plan and receiving information regarding execution of the action plan.

11. A computer system according to claim 1 wherein said processor is further configured to provide for receipt of journal input with an associated time of the journal input by receiving a record of a conversation relating to the issue.

12. A computer system according to claim 1 wherein said processor is further configured to permit an identification of one or more regulations by receiving an identification of one or more regulations that impact the issue.

13. A computer system according to claim 1 wherein said processor is configured to receive the identification of the action plan by receiving information identifying one or more instances in which the issue was previously raised.

14. A computer system according to claim 1 wherein said processor is configured to receive the identification of the issue along with a categorization of the issue by receiving a model of a product with which the issue is associated.

15. A computer program product for capturing knowledge during an issue resolution process, the computer program product comprising at least one computer-readable storage medium having computer-readable program code portions stored therein, the computer-readable program code portions comprising:
a first executable portion for receiving an identification of the issue along with associated personnel and a categorization of the issue;
a second executable portion for receiving an identification of an action plan for addressing the issue, wherein the second executable portion is also configured to permit an identification of one or more regulations that impact the issue;
a third executable portion for receiving information regarding execution of the action plan; and
a fourth executable portion for providing for storage of the identification of the issue, the identification of the action plan and the information regarding execution of the action plan,
wherein at least one of the second or third executable portions is further configured to permit entry of information identifying one or more documents related to at least one of the issue, the action plan or the execution of the action plan, and
wherein at least one of the first, second or third executable portions is further configured to provide for receipt of journal input in order to capture additional related information.

16. A computer program product according to claim 1 wherein each of the first, second and third executable portions are configured to provide for receipt of journal input including an associated time of each input.

17. A computer program product according to claim 1 wherein at least one of the first, second or third executable portions which is configured to provide for receipt of journal input is further configured to receive a record of a conversation relating to the issue including an associated time of each input.

18. A computer program product according to claim 1 wherein the second executable portion is further configured to receive an identification of one or more regulations that impact the issue.

19. A computer program product according to claim 1 wherein the second executable portion is further configured to receive information identifying one or more instances in which the issue was previously raised.

20. A computer program product according to claim 1 wherein the first executable portion is further configured to receive a model of a product with which the issue is associated in order to categorize the issue.
